(19) United States
(12) Patent Application Publication
(10) Pub. No.: US 2011/0133415 A1
(43) Pub. Date: Jun. 9, 2011

(54) Ring seal and retainer assembly

(76) Inventor: Kim Ngoc Vu, Yorba Linda, CA (US)

(21) Appl. No.: 12/653,022

(22) Filed: Dec. 7, 2009

(51) Int. Cl. F16L 25/00; F16J 15/06

(52) U.S. Cl. 277/608

(57) ABSTRACT

The ring seal and retainer assembly includes an annularly shaped ring seal defining a radial inner surface, a radial outer surface, first and second axial end surfaces, a central bore for fluid or gas passage, and a groove formed on the ring seal's radial outer surface forming a recessed interior wall. A retainer is provided for affixing and positioning a ring seal in a sealing assembly. The retainer includes a circular sidewall sized and positioned to engage and cover the ring seal's radial outer surface. The retainer includes a plurality of inwardly projecting tabs for projecting into the groove formed on the ring seal's radial outer surface. The tabs are flexible and sized to engage the ring seal groove's interior wall to center and affix the ring seal within the retainer. In a preferred embodiment, the circular sidewall includes upper and lower inwardly projecting edges forming a “C” shaped cross-section. The recess of the “C” is sized and positioned to receive the outer edge of the ring seal to affix the ring seal to the retainer.

### BACKGROUND OF THE INVENTION

The present invention relates to seals, often referred to as gaskets, for making a fluid or gas tight joint between opposed mating surfaces. More particularly, the present invention relates to retainers for positioning seals between opposed mating surfaces.

Ring seals are typically annularly shaped, defining an axially aligned hole for gas or fluid passage, two axially opposed end surfaces, a radial inner surface and a radial outer surface. The most simplistic ring seal includes planar end surfaces and smooth circular radial inner and outer surfaces which define the inner diameter (ID) and outer diameter (OD) of the ring seal.

An additional commonly used ring seal is circular and has a radial cross-section of a “C” shape. These “C seals” are constructed with the open side of the C construction facing the center of the ring such as described in U.S. Pat. No. 5,354,072, or with the open side of the C facing away from the center of the ring. As two mating surfaces are brought together with the C seal in the middle, the C seal is compressed with the open side of the C cross-section closing during compression. The ductile properties of the seal permit plastic deformation to occur without damaging the mating surfaces.

Additional seals which have been available include “V seals” which are also circular, but instead of having a “C” cross-section, the V seal has a “V” cross-section with the low point of the V constructed to point either inwardly or outwardly towards the center of the seal. Moreover, seals in the art include “Z seals” and simple “O rings”.

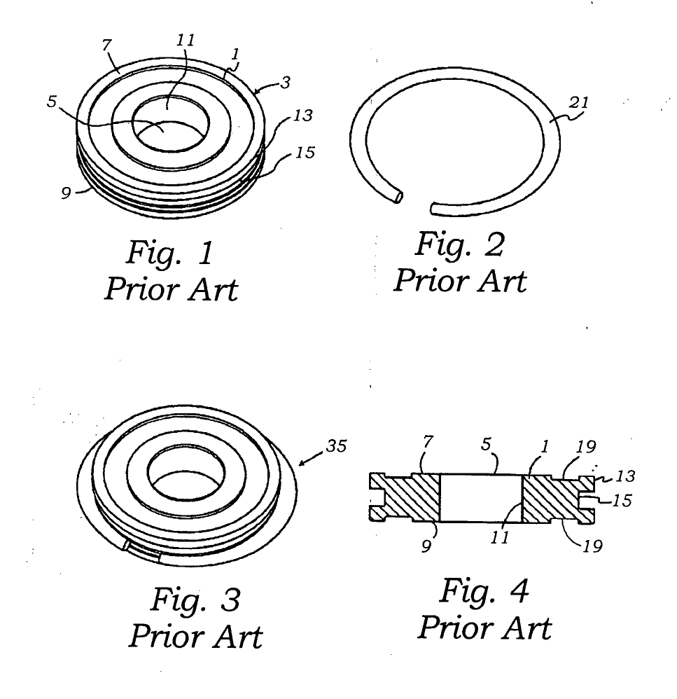

The above described ring seals often include a recessed sealing surface. With reference to FIGS. 1 and 4, the typical ring seal 1 includes an annular body configuration and a circumferential groove 15 formed into the ring seal's outer radial surface 13. In addition, the ring seal may include a recessed sealing surface 19 formed into each of the axial end surfaces. With reference to FIG. 7, in operation, the opposed mating surfaces 17 of the sealing assembly engage and form an air or fluid tight seal at the ring seal's sealing surface. With reference again to FIGS. 1 and 4, the sealing surface is recessed to protect the surface from becoming damaged during handling. For example, ring seals having planar surfaces often become scratched when placed on flat surfaces due to dirt or metal shavings scratching the ring seal's sealing surface. To overcome this drawback, the ring seal's sealing surface is recessed so as to not come into contact with debris prior to assembly within a sealing assembly. Unfortunately, ring seals having recessed sealing surfaces are expensive to manufacture and the recessed sealing surfaces are very difficult to polish. The parallelism is extremely critical between two recessed sealing surfaces. Usually, special machining equipment must be used to achieve the parallelism requirement.

Retainers are often used to hold and position a ring seal in place between two opposed mating surfaces. Retainers have been constructed in various forms. For example, U.S. Pat. No. 5,340,170 describes a retainer for positioning a gasket in a pipe joint. The retainer includes a cylindrical sidewall, an inwardly extending edge for engaging a ring seal and a plurality of claws for grabbing a pipe.

Meanwhile, U.S. Pat. No. 5,423,580 discloses a retainer having a semicircular sidewall for grasping the outer edge of a ring seal and extremity of a pipe. Moreover, additional retainer arrangements are disclosed in U.S. Pat. Nos. 4,552,389; 4,650,227; and 4,838,583.

A typical prior art ring seal and retainer assembly is shown in FIGS. 1-4. The ring seal 1 includes an annular body element 3 forming an axially aligned hole 5 for liquid or gas passage. Moreover, due to the annular construction of the ring seal 1, the ring seal includes a radial inner surface 11, a radial outer surface 13, a first axial end surface 7 and a second axial end surface 9. The radial outer surface 13 has been constructed with a curved recess forming a “C” shape. Additional constructions for the ring seal have included “V seals” and “Z seals”. As shown in FIGS. 1-4, prior art ring seals have included a radial outer surface having a groove 15. The groove has been constructed with squared planar surfaces, or constructed with curved surfaces. The prior art ring seals have included a recessed sealing surface 19 formed on each of the axial end surfaces.

Prior art retainers have taken a wide variety of forms. As illustrated in FIGS. 1-4, a retainer may be obtained from a single loop of a coil spring, which is then formed into a circular band. The coil retainer is positioned within the ring seal's circumferential groove so that the outer edge of the coil projects outwardly beyond the edge of the ring seal. Meanwhile, the opposed mating surfaces include a fitting including a recess sized and positioned for receipt of the coil retainer's edge. Once press fit into place, the retainer is restrained from inadvertent movement.

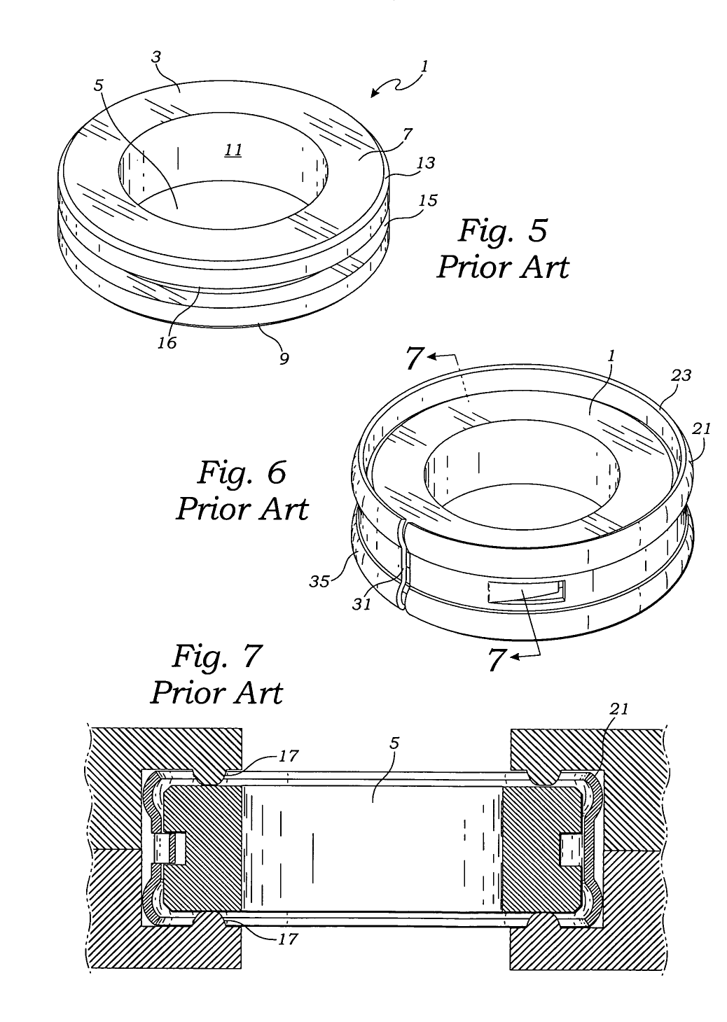

FIGS. 5-7 illustrate retainers shown in U.S. Patent Publication No. 2008/0191426 naming Doyle as the inventor. U.S. Patent Publication No. 2008/0191426, which is incorporated by reference in its entirety, discloses retainers which are circular in shape, and include a sidewall sized and positioned to cover and engage a ring seal's radial outer surface. In some embodiments, the retainers' circular sidewall projects axially beyond the ring seal's axial end surfaces. Furthermore, in some embodiments, the retainer extends axially beyond one or both of the ring seal's axial end surfaces to provide an arcuate flange having a concave interior and a convex exterior. The arcuate flange extends radially outward from the retainer's circular sidewall so as to provide the ring seal and retainer assembly with a substantially increased radius sized to reside in a press-fit arrangement within a counterbore formed within one of the opposed mating surfaces of a component block.

U.S. Patent Publication No. 2008/0191426 also illustrates retainers having one or more circumferential ridges sized and positioned to project inwardly from the retainer's circular sidewall into the ring seal's circumferential groove. The circumferential ridge projects into the ring seal's groove to inhibit the annular retainer from inadvertently being dislodged or disengaged from the ring seal.

Unfortunately, the above-described retainers all suffer from significant disadvantages. For example, the coil retainer and sharp edges of the ring seal are prone to scratching, or otherwise harming, the opposed mating surfaces. This can impede the ring seal's ability to provide a gas or fluid tight seal. Moreover, ring seals having recessed sealing surfaces are expensive to manufacture and the parallelism requirement between the two recessed sealing surfaces presents a high risk of leakage. Meanwhile, the retainer described in U.S. Pat. No. 5,340,170 is capable of use only with a ring seal of an unusual construction. Furthermore, the retainer disclosed in U.S. Pat. No. 5,423,580 also does not protect the edge of a ring seal from undesirably scratching one of the opposed mating surfaces. The retainers disclosed in U.S. Patent Publication No. 2008/0191426 can undesirably decouple from retainers meant to be held in place.

Thus, it would be desirable to provide an improved ring seal and retainer assembly which is inexpensive to manufacture and constructed to eliminate the risk of leakage.

In addition, it would be desirable to provide an improved ring seal and retainer assembly which does not require recessed sealing surfaces which are expensive to manufacture and difficult to polish.

Moreover, it would be desirable to provide an improved ring seal and retainer assembly which provides protection against damage to a ring seal's sealing surfaces, while not being susceptible to scratching or otherwise marring the opposed mating surfaces prior to forming an air-tight or gas-tight seal.

Still an additional desirable feature for a retainer would be that it adequately hold ring seals without ring seals inadvertently decoupling from the retainer.

### SUMMARY OF THE INVENTION

The present invention addresses the aforementioned disadvantages by providing an improved ring seal and retainer assembly. To this end, the ring seal is annularly shaped having an axially aligned hole for gas or fluid passage. The ring seal further includes a radial inner surface, a radial outer surface and first and second axial end surfaces. Meanwhile, the retainer is circular in shape, and includes a sidewall which is sized and positioned to cover, though not necessarily engage the ring seal's radial outer surface. The sidewall protects the ring seal's radial outer surface from becoming damaged prior to assembly within a sealing assembly, and protects the opposed mating surfaces from being damaged by preventing the ring seal's outer edge from scratching the opposed mating surfaces during assembly. Moreover, preferably, the retainer's circular sidewall projects axially beyond the ring seal's axial end surfaces. The protruding extremities of the circular sidewall protect the ring seal's axial end surfaces during storage and transportation, thereby eliminating the need for the ring seal having a recessed sealing surface.

To maintain the annular retainer affixed to the ring seal, the ring seal includes a circumferential groove which circumnavigates the ring seal's radial outer surface. The circumferential groove may be constructed in similar form to grooves constructed in the prior art, such as the groove including planar walls forming a squared recess. Alternatively, the circumferential groove may be formed in alternative configurations, such as V-shaped or rounded recesses as can be determined by those skilled in the art. However, for each construction, the circumferential groove includes an interior wall that is preferably planar, though curved interior walls may be implemented.

Meanwhile, the annular retainer includes a plurality of tabs sized and positioned to project inwardly from the retainer's circular sidewall into the ring seal's circumferential groove. In a preferred embodiment, the annular retainer is provided with three ridges positioned at 120° increments around the annular retainer's sidewall, though additional tabs may be provided. The inwardly projecting tabs extend into the ring seal's groove to inhibit the annular retainer from inadvertently being dislodged or disengaged from the ring seal.

Of importance, the tabs are flexible so as to bias inwardly and sized to engage the ring seal's circumferential groove's interior wall. The engagement of the flexible tabs with the groove's interior wall functions to center a ring seal within a retainer aperture and to inhibit disengagement of a ring seal from a retainer.

Preferably, the annular retainer is formed having an inwardly facing “C” shaped cross-section. To this end, the annular retainer's circular sidewall includes upper and lower inwardly projecting edges which grasp the ring seal's axial end surfaces. The first and second edges of the circular sidewall partially cover and engage the ring seal's axial end surfaces to affix the annular retainer to the ring seal. However, the axial end surfaces remain substantially uncovered by the sidewall edges so that the axial end surfaces can engage and form a seal with two axially opposed mating surfaces. Moreover, the edges project axially beyond the axial end surfaces to provide protection for the axial end surface, thereby eliminating the need for the ring seal including recessed sealing surfaces.

It is thus an object of the present invention to provide a ring seal and retainer assembly which is very reputable, of high quality, inexpensive to manufacture and reliable for providing a seal between two glands.

It is still an additional object of the invention to provide an improved ring seal and retainer assembly which does not require recessed sealing surfaces which are expensive to manufacture and difficult to polish.

Moreover, it is an object of the present invention to provide an improved ring seal and retainer assembly which provides protection against damage to a ring seal's sealing surfaces, while not being susceptible to scratching or otherwise marring the opposed mating surfaces prior to forming an air-tight or gas-tight seal.

It is an additional object of the invention to provide a ring seal and retainer assembly which is not prone to being scratched or damaged, and which is not prone to scratching or damaging the mating surfaces between which a seal is sought.

Still an additional object of the invention to provide a ring seal and retainer assembly wherein the retainer is firmly affixed to the ring seal and not prone to decoupling.

### DETAILED DESCRIPTION OF THE DRAWINGS

FIG. 1 is a perspective view illustrating a ring seal of the prior art;

FIG. 2 is a perspective view illustrating a retainer of the prior art;

FIG. 3 is a perspective view illustrating a ring seal and retainer assembly of the prior art;

FIG. 4 is a cross-sectional view illustrating a ring seal of the prior art;

FIG. 5 is a perspective view illustrating a ring seal and retainer assembly as disclosed in U.S. Patent Publication No. 2008/0191426;

FIG. 6 is a perspective view illustrating the ring seal and retainer as disclosed in U.S. Patent Publication No. 2008/0191426;

FIG. 7 is a cross-sectional view of the seal and retainer of FIG. 6;

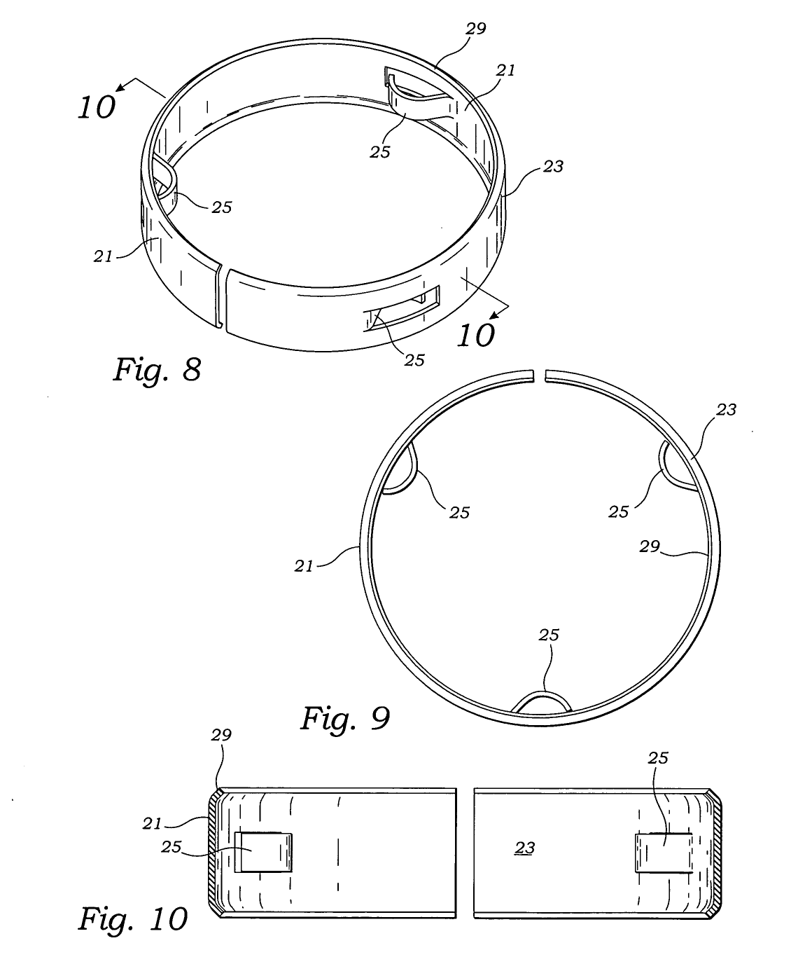

FIG. 8 is a perspective view illustrating a retainer of the present invention;

FIG. 9 is a top plan view retainer of the present invention illustrated in FIG. 8;

FIG. 10 is a side cross-sectional view illustrating the retainer of FIG. 8;

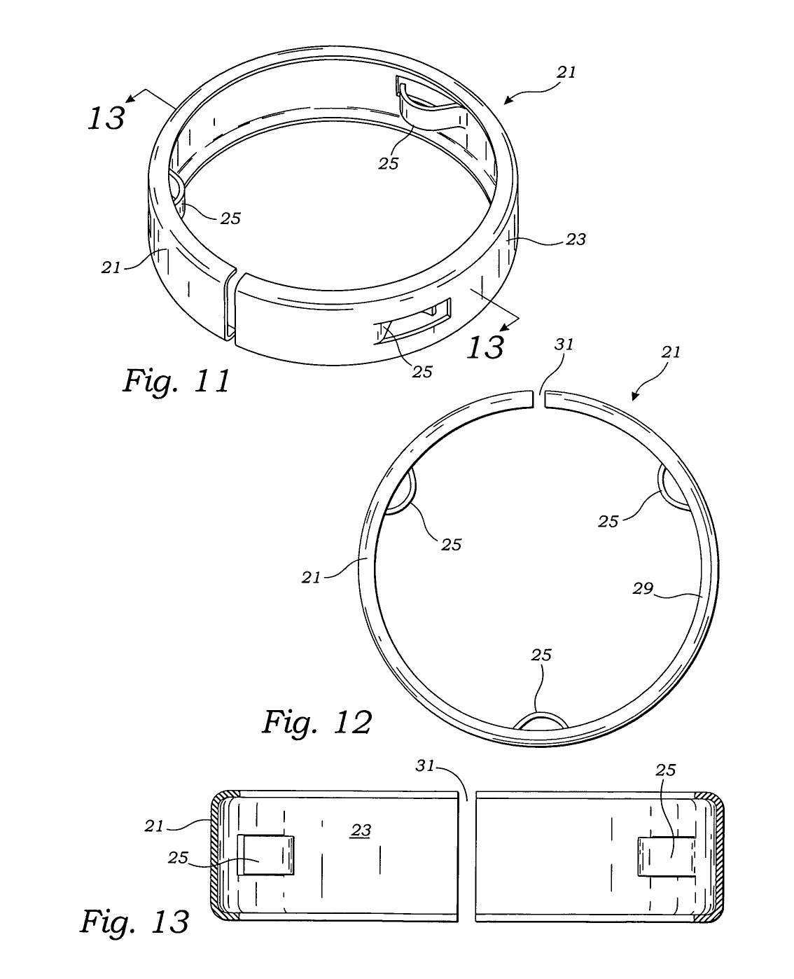

FIG. 11 is a perspective view illustrating a second embodiment of a retainer of the present invention;

FIG. 12 is a top plan view retainer of the present invention illustrated in FIG. 11;

FIG. 13 is a side cross-sectional view illustrating the retainer of FIG. 11;

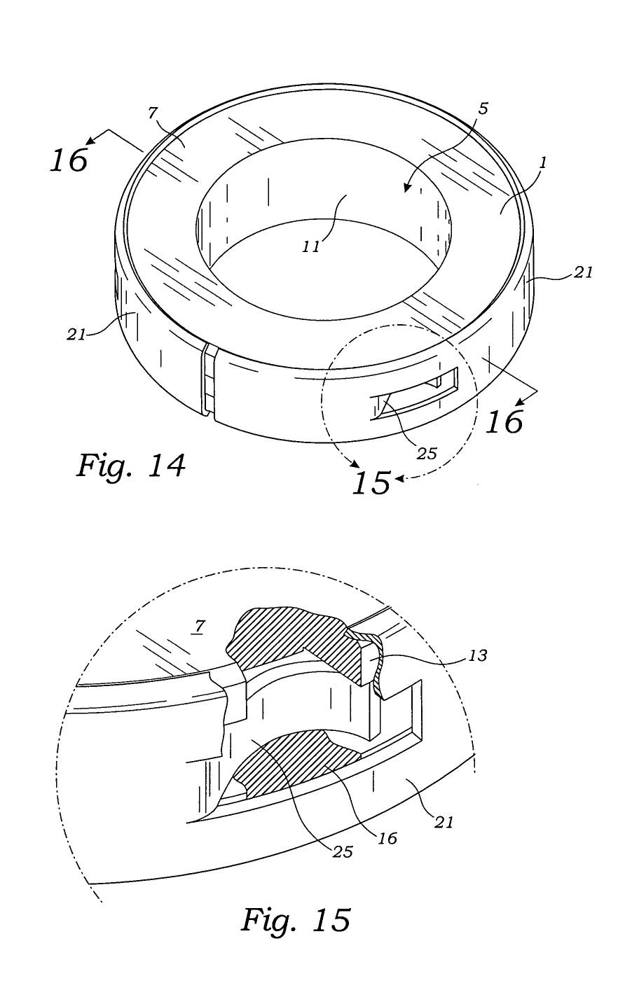

FIG. 14 is a perspective view of a ring seal and retainer assembly of the present invention utilizing the retainer shown in FIGS. 11-13;

FIG. 15 is a perspective cut-away view of the ring seal and retainer of FIG. 14 illustrating the engagement of retainer tabs biasly engaging a ring seal's circumferential groove interior wall in accordance with the present invention;

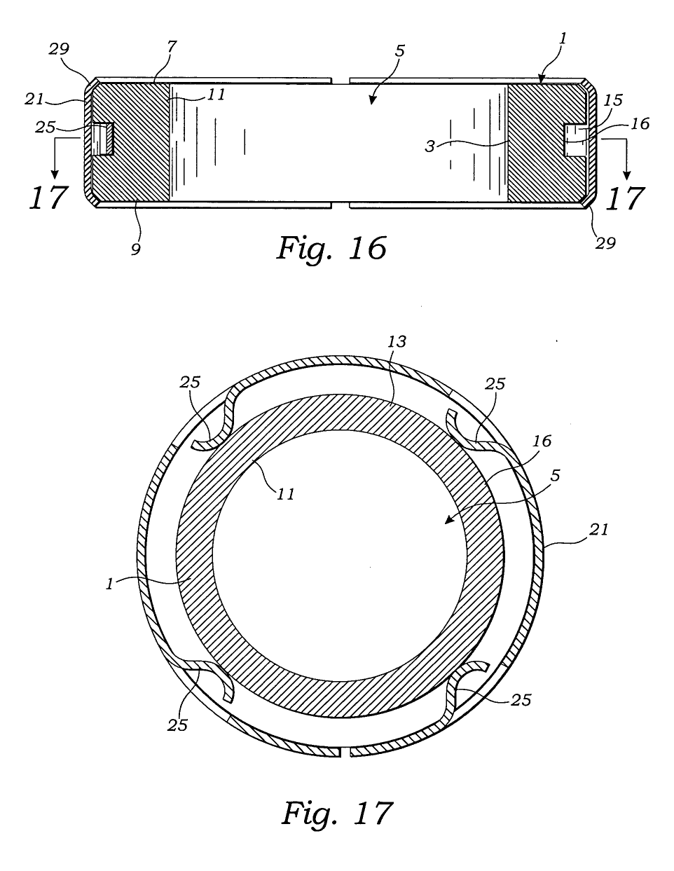

FIG. 16 is a side cut-away view of the ring seal and retainer of FIG. 14 illustrating the engagement of retainer tabs biasly engaging a ring seal's circumferential groove interior wall in accordance with the present invention; and

FIG. 17 is a top cut-away view of the ring seal and retainer of FIG. 16 illustrating the engagement of retainer tabs biasly engaging a ring seal's circumferential groove interior wall in accordance with the present invention.

### DETAILED DESCRIPTION OF THE INVENTION

While the present invention is susceptible of embodiment in various forms, as shown in the drawings, hereinafter will be described the presently preferred embodiments of the invention with the understanding that the present disclosure is to be considered as an exemplification of the invention and it is not intended to limit the invention to the specific embodiments illustrated.

As shown in FIGS. 8-17, the ring seal and retainer assembly of the present invention includes a ring seal 1 and a retainer 21. Though the ring seal may be constructed in various configurations as can be determined by those skilled in the art, a preferred ring seal 1 includes an annular body element 3 forming an axially aligned hole for liquid or gas passage. Moreover, due to the annular construction of the ring seal 1, the ring seal includes a radial inner surface 11, a radial outer surface 13, a first axial end surface 7 and a second axial end surface 9. Each of these surfaces may take any number of configurations, including planar or curved constructions. For example, the radial outer surface 13 may be constructed with a curved recess forming a “C” shape, in similar construction as a typical “C seal”. As shown in the figures, the ring seal's radial outer surface includes a groove 15. The groove may include substantially squared planar surfaces, or the groove may include curved surfaces or other constructions as can be determined by those skilled in the art. However, for each of these construction, the groove 15 will include an interior wall 16.

Meanwhile, the first and second axial end surfaces, 7 and 9 respectively, are provided for forming a seal between opposed substantially parallel mating surfaces 17 (see FIG. 7) for forming a fluid or gaseous tight seal between the opposed mating surfaces. As shown in the figures, the ring seal's axial end surfaces 7 and 9 may be substantially planar. Alternatively, the seal of the ring seals 1 may include a recessed sealing surface or may include one or more concentric circular projections (not shown) rising from the surface of the axial end surfaces. The circular projections are typically only a few thousandths of an inch high and undergo significant plastic deformation when the ring seal is compressed to provide a gas or liquid tight seal.

The retainer for use with the ring seal and retainer assembly of the present invention includes a circular sidewall 23 sized and positioned to substantially engage and cover the ring seal's radial outer surface 13. In particular, the circular sidewall 23 extends axially so as to cover, though not necessarily engage, the ring seal's radial outer surface 13 so as to inhibit the ring seal's sharp metal edge from scratching or otherwise marring the sealing surfaces during assembly between two opposed sealing surfaces. Preferably, as shown in FIGS. 10 and 13, the retainer's circular sidewall has an axial length sufficient to project beyond the ring seal's axial surfaces. Projecting the circular sidewall beyond the ring seal's axial end surfaces provides protection to the ring seal during storage and inhibits the ring seal from becoming scratched or damaged when placed upon a flat surface where dirt or metal shavings could scratch the axial end surfaces of the ring seal. Accordingly, a retainer having a circular sidewall that projects axially beyond the axial end surfaces eliminates the need for the ring seal having costly recessed sealing surfaces (see FIGS. 1 and 4).

With reference to FIGS. 8-17, the annular ring seal 1 includes a circumferential groove 15, while the retainer 21 includes a plurality of tabs 25 which are concentrically positioned and formed to project inwardly from the retainer's circular sidewall 23. As shown in FIGS. 8-17, the tabs are sized and positioned to circumnavigate the inner surface of the retainer's circular sidewall so as to project into the ring seal groove 15 when the ring seal and retainer are assembled together.

Of importance, the plurality of tabs 25 are flexible so as to bias inwardly and sized to engage the ring seal groove's interior wall 16. The flexibility of the tabs may be achieved by the inherent properties in the tabs' material. For example, as shown in the FIGS. 8-17, preferred tabs are mechanically “punched” or otherwise formed from the retainer sidewall to provide arcuate tabs wherein the inner curved portion of the tabs engage the ring seal groove's interior wall 16. The arcuate tabs being curved in the radial plane of the ring seal provides superior resistance to axial movement compared to the simple straight tabs of the prior art assembly shown in FIG. 6 and FIG. 7 thereby preventing the retainer and seal from becoming unintentionally separated. For this construction, the ductile properties of the retainer material provide for flexibility of the tabs. Preferred retainers are made of 300 series stainless steel providing stiff but flexible tabs. Other materials may be selected to provide greater or lesser flexibility.

Advantageously, engagement of the flexible tabs 25 with groove's interior wall 16 functions to center a ring seal within the retainer and to inhibit disengagement of a ring seal from a retainer. Furthermore, once assembled, the retainer's tabs restrict axial and tangential motion of the retainer relative to the ring seal.

As shown in FIGS. 8-17, preferably three tabs 25 are provided which are positioned at 120 degree increments around the retainer's circular sidewall for affixing the retainer 21 to the ring seal 1. However, any number of tabs 25 may be provided without departing from the spirit and scope of the invention. Again, the tabs are sized and positioned to project into the ring seal groove to inhibit movement of the retainer relative to the ring seal. Moreover, the flexible tabs engagement with the groove's interior wall provides for better centering of the ring seal within the retainer than prior art ring seal and retainer assemblies.

With reference to FIGS. 10 & 13, preferably the retainer sidewall includes inwardly projecting edges 29. In addition to the retainer including an inwardly projecting tabs 25 which project into the ring seal's circular groove 15, the retainer upper and lower edge portions 29 project inwardly from the top and bottom of the retainer's circular sidewall 23 so as to grasp and engage a ring seal's axial end surfaces. To this end, the retainer forms an inwardly facing “C” cross-section in which the recess of the “C” envelops the ring seal's radial outer surface 13 and a small portion of the axial end surfaces 13. However, the axial end surfaces remain substantially uncovered by the retainer's inwardly projecting edges 29 so that the axial end surfaces can engage and form a seal with two axially opposed mating surfaces. The inwardly facing “C” cross-section formed by the projecting edges 29 combined with sidewall 23 provides the retainer 21 with superior resistance against outward radial stretching compared to the slight stiffening provided by the simple corrugations of the prior art assembly shown in FIG. 7. The retainer sidewall edges 29 may constructed in various forms. For example, FIGS. 8-10 illustrate an embodiment wherein the edges are angled at 45° relative to the retainer's sidewall 23. Meanwhile, FIGS. 11-13 illustrate an alternative embodiment wherein the edges are angled at 90° relative to the retainer's sidewall 23. Still other constructions can be developed by those skilled in the art without undue experimentation.

The ring seal 1 and retainer 21 of the present invention may be manufactured by various techniques known to those skilled in the art. Furthermore, the retainer may be constructed to include a slit 31 to assist in affixing the retainer to the ring seal. Moreover, the ring seal and retainer may be constructed of various materials known to those skilled in the art. It is preferred that the ring seal 1 be manufactured of a metal such as aluminum, copper, silver, nickel, steel or stainless steel. Even more preferably, the retainer is made of stainless steel, and preferably a 300 series stainless steel. However, the ring seal and retainer may be manufactured of other materials without departing from the spirit and scope of the invention.

Having described the invention in such terms to enable those skilled in the art to make and use it and having identified the presently understood best mode of practicing it, I claim:

1. A ring seal and retainer assembly wherein said ring seal is adapted to be compressed and decompressed in the axial direction for making a sealed joint between first and second axially mating opposed surfaces, the ring seal and retainer assembly comprising:
an annularly shaped ring seal having an axially aligned hole for gas or fluid passage, a radial inner surface, a radial outer surface, and substantially uncovered first and second axial end surfaces constructed to engage the axially opposed mating surfaces, said radial outer surface including a circumferential groove having an interior wall at least partially circumnavigating said radial outer surface;
a retainer having an outer circular sidewall, said retainer substantially circumnavigating said ring seal so that said circular sidewall predominantly covers said ring seal's radial outer surface, said retainer having a plurality of tabs sized and positioned to project inwardly from said circular sidewall into said groove, said tabs being flexible so as to bias inwardly and sized to engage said groove's interior wall to center said ring seal within said retainer and to inhibit disengagement of said retainer from said ring seal; and
said ring seal's first and second axial end surfaces being predominately uncovered by said retainer so as to enable said uncovered portions of said first and second axial end surfaces to engage and form a seal with two axially opposed surfaces.

2. The ring seal and retainer assembly of claim 1 wherein said circular sidewall has edges which project axially beyond said ring seal's axial end surfaces.

3. The ring seal and retainer assembly of claim 2 wherein the edges of said circular sidewall project radially inward to partially cover said ring seal's axial end surfaces so as to further inhibit disengagement of said retainer from said ring seal.

4. The ring seal and retainer assembly of claim 1 wherein said plurality of tabs includes three tabs.

5. The ring seal and retainer assembly of claim 1 wherein said plurality of tabs includes three tabs positioned at 120 degree increments around said retainer.

6. The ring seal and retainer assembly of claim 5 wherein said circular sidewall has edges which project axially beyond said ring seal's axial end surfaces and wherein the edges of said circular sidewall project radially inward to partially cover said ring seal's axial end surfaces so as to further inhibit disengagement of said retainer from said ring seal.

7. A ring seal and retainer assembly wherein said ring seal is adapted to be compressed and decompressed in the axial direction for making a sealed joint between first and second axially mating opposed surfaces, the ring seal and retainer assembly comprising:
an annularly shaped ring seal having an axially aligned hole for gas or fluid passage, a radial inner surface, a radial outer surface, and substantially uncovered first and second axial end surfaces constructed to engage the axially opposed mating surfaces, said radial outer surface including a circumferential groove having an interior wall at least partially circumnavigating said radial outer surface;
a retainer having an outer circular sidewall, said retainer substantially circumnavigating said ring seal so that said circular sidewall predominantly covers said ring seal's radial outer surface, said retainer having three tabs sized and positioned at 120 degree increments around said retainer to project inwardly from said circular sidewall into said groove, said tabs being flexible so as to bias inwardly and sized to engage said groove's interior wall to center said ring seal within said retainer and to inhibit disengagement of said retainer from said ring seal; and
said ring seal's first and second axial end surfaces being predominately uncovered by said retainer so as to enable said uncovered portions of said first and second axial end surfaces to engage and form a seal with two axially opposed surfaces.

8. The ring seal and retainer assembly of claim 7 wherein said circular sidewall has edges which project axially beyond said ring seal's axial end surfaces.

9. The ring seal and retainer assembly of claim 8 wherein the edges of said circular sidewall project radially inward to partially cover said ring seal's axial end surfaces so as to further inhibit disengagement of said retainer from said ring seal.

10. The ring seal and retainer of claim 9 wherein said tabs having arcuate shape.
